(19) United States
(12) Patent Application Publication
(10) Pub. No.: US 2004/0114648 A1
(43) Pub. Date: Jun. 17, 2004

(54) Laser apparatus in which laser diodes and corresponding collimator lenses are fixed to multiple steps provided in block

(75) Inventors: Kazuhiko Nagano, Kanagawa-ken (JP); Yoji Okazaki, Kanagawa-ken (JP); Fusao Yamanaka, Kanagawa-ken (JP); Teruhiko Kuramachi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/670,792

(22) Filed: Sep. 26, 2003

(30) Foreign Application Priority Data
Sep. 30, 2002 (JP) 287640/2002
Mar. 6, 2003 (JP) 060047/2003

(51) Int. Cl. H01S 3/04; H01S 3/08

(52) U.S. Cl. 372/36; 372/108

(57) ABSTRACT

A laser apparatus includes: a block having a stepped shape formed with a plurality of mount portions which have different heights and are arranged in a first direction parallel to an optical axis in order of height; and a plurality of a collimator-lens array and a plurality of laser diodes, where the collimator-lens array in each of the plurality of sets is constituted by a plurality of collimator lenses which are arranged along a second direction and collimate laser beams emitted from the plurality of laser diodes in the set. The plurality of laser diodes and the collimator-lens array in each of the plurality of sets are fixed to one of the plurality of mount portions so that light-emission points of the plurality of laser diodes in the set are aligned in a third direction.

### BACKGROUND OF THE INVENTION

1. Field of the Invention

The present invention relates to a laser apparatus in which a plurality of laser diodes are fixedly arranged on a block.

2. Description of the Related Art

The following documents (1) and (2) disclose information related to the present invention.

(1) Japanese Journal of Applied Physics Part 2 Letters, vol. 37, 1998, pp. L1020-1022

(2) U.S. Patent Laid-Open No. 20020090172

Conventionally, in order to generate a laser beam having an ultraviolet wavelength, wavelength conversion lasers, excimer lasers, and Ar lasers are used. In the wavelength conversion lasers, infrared light emitted from a solid-state laser excited with a semiconductor laser is converted into a third harmonic having an ultraviolet wavelength.

Further, recently, GaN-based compound semiconductor lasers (laser diodes) which emit a laser beam having a wavelength in the vicinity of 400 nm have been provided, for example, as disclosed in document (1).

Light sources which emit laser beams having the wavelengths as mentioned above are being considered for use in exposure systems for exposure of photosensitive materials which are sensitive to light in a predetermined wavelength range including an ultraviolet wavelength range of 350 to 420 nm. In such a case, the light sources for exposure are required to have sufficient output power for exposing the photosensitive materials. The above predetermined wavelength range is hereinafter referred to as the ultraviolet range.

However, the excimer lasers are large in size, and the manufacturing costs and maintenance costs of the excimer lasers are high.

In the wavelength conversion lasers which convert infrared light into a third harmonic in the ultraviolet range, the wavelength conversion efficiency is very low. Therefore, it is very difficult to achieve high output power. In a typical wavelength conversion laser at the currently practical level, a solid-state laser medium is excited with a semiconductor laser having an output power of 30 W so as to output a fundamental harmonic having a wavelength of 1,064 nm and an output power of 10 W, the fundamental harmonic is converted into a second harmonic having a wavelength of 532 nm and an output power of 3 W, and a third harmonic having a wavelength of 355 nm (i.e., a sum frequency of the first and second harmonics) and an output power of 1 W is obtained. In this wavelength conversion laser, the efficiency in electric-to-optical conversion in the semiconductor laser is about 50%, and the efficiency in conversion to the ultraviolet light is as low as about 1.7%. In addition, since an optical wavelength conversion element is used in the above wavelength conversion laser, and the optical wavelength conversion element is expensive, the manufacturing cost of the wavelength conversion laser is high.

Further, the efficiency in electric-to-optical conversion in the Ar lasers is as low as 0.005%, and the lifetime thereof is as short as about 1,000 hours.

On the other hand, since it is difficult to obtain a low-dislocation GaN crystal substrate, an attempt has been made to achieve high output power and reliability in a GaN-based compound semiconductor laser. In the attempt, a low-dislocation region having a width of about 5 micrometers is produced by a growth method called ELOG (epitaxial lateral overgrowth), and a laser region is formed on the low-dislocation region. However, even in the attempt, it is difficult to obtain a low-dislocation substrate having a large area. Therefore, no GaN-based compound semiconductor laser having a high output power of 500 mW to 1 W has yet been commercialized.

In another attempt to increase output power of a semiconductor laser, for example, it has been considered to form a hundred cavities each of which outputs light with 100 mW so as to obtain a total output power of 10 W. However, it is almost unrealistic to manufacture as many as 100 cavities with high yield. In particular, it is difficult to manufacture GaN-based compound semiconductor lasers each having many cavities since manufacture of GaN-based compound semiconductor lasers with a high yield of 99% or greater is difficult even when the GaN-based compound semiconductor lasers each have a single cavity.

In view of the above circumstances, there have been proposed laser apparatuses having particularly high output power, as disclosed in document (2).

The laser apparatuses disclosed in document (2) are constituted by a plurality of laser diodes, a single multimode optical fiber, and an optical condensing system which collects laser beams emitted from the plurality of laser diodes, and couples the collected laser beams to the multimode optical fiber. In a preferable embodiment of the laser apparatus, the plurality of laser diodes are arranged so that light-emission points of the plurality of laser diodes are aligned along a certain direction.

On the other hand, in a laser apparatus disclosed in document (1), a plurality of multicavity laser-diode chips each having a plurality of light-emission points are fixedly arranged.

When a plurality of laser diodes are arranged so that the light-emission points are aligned along a certain direction, normally, the plurality of laser diodes are fixed to a block such as a heat dissipation block made of copper or copper alloy.

Since the laser beams emitted from each laser diode in the disclosed laser apparatuses are divergent, it is necessary to collimate the divergent laser beams through collimator lenses, and make the laser beams converge on a point. At this time, the collimator lenses may be separately arranged, or integrally formed into a collimator-lens array in which collimator-lens portions are arranged along a line. In the latter case, downsizing and adjustment of the laser apparatuses become easy. In addition, in either case, it is necessary to accurately position the laser diodes and the collimator lenses or the collimator-lens array so that the optical axes of the collimator lenses (or collimator-lens portions constituting the collimator-lens array) respectively coincide with the light-emission axes of the laser diodes. If the above positioning is inaccurately performed, it is impossible to make the plurality of laser beams converge on a small spot. Therefore, for example, when a photosensitive material is exposed to the laser beams in order to form an image, it becomes impossible to form a fine image by the exposure.

Further, there is a demand to realize a laser apparatus having higher output power by combining greater numbers of laser diodes and collimator lenses. In order to meet the demand, as disclosed in Japanese Patent Application No. 2002-201902, it has been proposed to stack a plurality of blocks to each of which a plurality of laser diodes and a collimator-lens array are fixed, in a plurality of layers. However, in this case, it is necessary to achieve alignment among the plurality of blocks. Therefore, a great number of man-hours are required in assembly of the laser apparatus, and thus the manufacturing cost of the laser apparatus increases.

### SUMMARY OF THE INVENTION

The present invention has been developed in view of the above circumstances.

It is an object of the present invention to provide a laser apparatus which has a great number of sets of a collimator-lens array and a plurality of laser diodes so as to achieve high output power, and can be easily assembled.

In order to accomplish the above object, the present invention is provided. According to the present invention, there is provided a laser apparatus comprising: a block having a stepped shape formed with a plurality of mount portions which have different heights and are arranged in a first direction parallel to an optical axis in order of height; and a plurality of sets each comprising a collimator-lens array and a plurality of laser diodes, where the collimator-lens array in each of the plurality of sets is constituted by a plurality of collimator lenses which are arranged along a second direction and collimate laser beams emitted from the plurality of laser diodes in the set. The plurality of laser diodes and the collimator-lens array in each of the plurality of sets are fixed to one of the plurality of mount portions so that light-emission points of the plurality of laser diodes in each of the plurality of sets are aligned in a third direction.

In the above construction, the plurality of sets of a collimator-lens array and a plurality of laser diodes are fixed to the plurality of mount portions of the block. Since the plurality of mount portions have different heights so as to form a stepped shape, the plurality of sets can be vertically displaced from each other. Therefore, a great number of sets of a collimator-lens array and a plurality of laser diodes can be fixed to the block. Thus, it is possible to collect a great number of laser beams from the great number of laser diodes, and obtain a laser beam with high output power.

In addition, since a plurality of laser diodes and a collimator-lens array in each set are each fixed to one of the plurality of mount portions, it is unnecessary to precisely adjust alignment between a plurality of separate blocks as in the case where a plurality of separate blocks are stacked. Therefore, the laser apparatus according to the present invention can be easily assembled.

In the case where a plurality of arrays of laser diodes are arranged in a direction different from a direction along which light-emission points of laser diodes in each array is aligned (so that the laser diodes constituting the plurality of arrays are two-dimensionally arrayed), and a plurality of collimator-lens arrays are also arranged in correspondence with the plurality of arrays of laser diodes (i.e., in the same direction as the plurality of arrays of laser diodes), it is possible to arrange a greater number of laser diodes with a higher density, and obtain an optically-multiplexed laser beam with particularly high output power.

Preferably, the laser apparatus according to the present invention may also have one or any possible combination of the following additional features (i) to (vii).

(i) A bottom surface of the collimator-lens array in each of the plurality of sets is fixed to an upper surface of one of the plurality of mount portions so that the collimator-lens array is supported by the upper surface of the one of the plurality of mount portions.

In order to secure aging reliability of a laser apparatus, it is desirable to fix constituent elements with solder. However, when heat fixation with brazing material (solder) is used in assembly of the conventional laser apparatuses, the collimator-lens array is likely to move in the vertical direction during the heat fixation of the collimator-lens array.

On the other hand, in the case of the laser apparatus having the feature (i), it is possible to prevent movement of the collimator-lens array in the vertical direction during execution of work for fixing the collimator-lens array to the block.

That is, in the case where an end face or the like of the collimator-lens array extending in the vertical direction is held against a block to position the collimator-lens array relative to the block, and the collimator-lens array is fixed to the block with solder, sometimes the collimator-lens array moves in the vertical direction by about 0.5 to 2 micrometers during a cooling process after the soldering, due to the difference in the linear expansion coefficient between the collimator-lens array and the block. However, when the collimator-lens array is fixed to the block in such a manner that a bottom surface of the collimator-lens array is supported by an upper surface of one of the plurality of mount portions of the block, movement of the collimator-lens array in the vertical direction, relative to the block, is restricted. Therefore, even when the collimator-lens array is fixed to the block with solder, it is possible to surely prevent the movement of the collimator-lens array in the vertical direction.

(ii) The plurality of laser diodes in each of the plurality of sets is fixed to a surface of one of the plurality of mount portions, and reference marks which indicate fixation positions of the plurality of laser diodes are arranged on the surface of the one of the plurality of mount portions. In this case, when the plurality of laser diodes are mounted on the block, the fixation positions of the plurality of laser diodes in the direction along which the light-emission points of the plurality of laser diodes are aligned can be easily determined by referring to the reference marks. Therefore, the assembly process of the laser apparatus can be simplified, and the accuracy of the positioning of the laser diodes in the horizontal direction can be maintained high.

(iii) The plurality of laser diodes in each of the plurality of sets are realized by a multicavity laser diode chip having a plurality of light-emission points.

(iv) The plurality of laser diodes in each of the plurality of sets are realized by a plurality of multicavity laser diode chips each having a plurality of light-emission points. In this case, the laser apparatus has particularly high output power.

(v) The plurality of laser diodes in each of the plurality of sets are each a single-cavity laser diode chip having a single light-emission point.

(vi) The block is integrally formed by cutting out from a single piece of material.

(vii) The block is formed by combining a plurality of planar plates which are stacked in one of a vertical direction and the first direction.

In the case of the laser apparatus having the feature (vii), the block can be formed at lower cost than the laser apparatus having the feature (vi). Therefore, the laser apparatus having the feature (vii) can be produced at lower cost than the laser apparatus having the feature (vi).

For example, the above planar plates are preferably made of copper, copper alloy, silicon, aluminum nitride (AlN), or the like, and are normally finished by two-sided polishing. Therefore, it is possible to obtain planar plates having high flatness, high degrees of parallelism, and precise thicknesses at low cost. Thus, the dimensional precision of the block formed by combining a plurality of planar plates which are stacked in one of a vertical direction and the first direction is comparable to that of the block cut out from a single piece of material.

(viii) In the laser apparatus having the feature (vi), the plurality of planar plates are arranged in correspondence with steps constituting the stepped shape, respectively. In this case, it is possible to reduce the number of the planar plates. Therefore, the man-hour needed for producing the block can be reduced, and thus laser apparatus can be produced at further lower cost.

### DESCRIPTION OF THE DRAWINGS

FIG. 1 is a plan view of a laser apparatus according to a first embodiment of the present invention.

FIG. 2 is a side view of the laser apparatus of FIG. 1.

FIG. 3 is a front view of a portion of the laser apparatus of FIG. 1.

FIG. 4 is a plan view of a laser apparatus according to a second embodiment of the present invention.

FIG. 5 is a side view of the laser apparatus of FIG. 4.

FIG. 6 is a plan view of a laser apparatus according to a third embodiment of the present invention.

FIG. 7 is a side view of the laser apparatus of FIG. 6.

FIG. 8 is a side view of a laser apparatus according to a fourth embodiment of the present invention.

FIG. 9 is a side view of a laser apparatus according to a fifth embodiment of the present invention.

### DESCRIPTION OF PREFERRED EMBODIMENTS

Embodiments of the present invention are explained in detail below with reference to drawings.

### First Embodiment

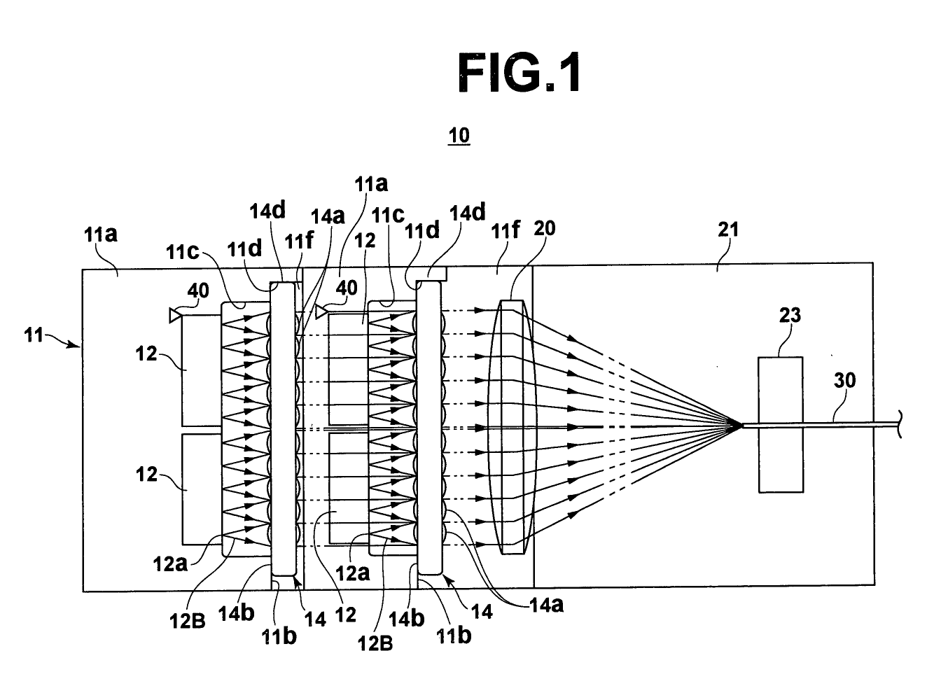

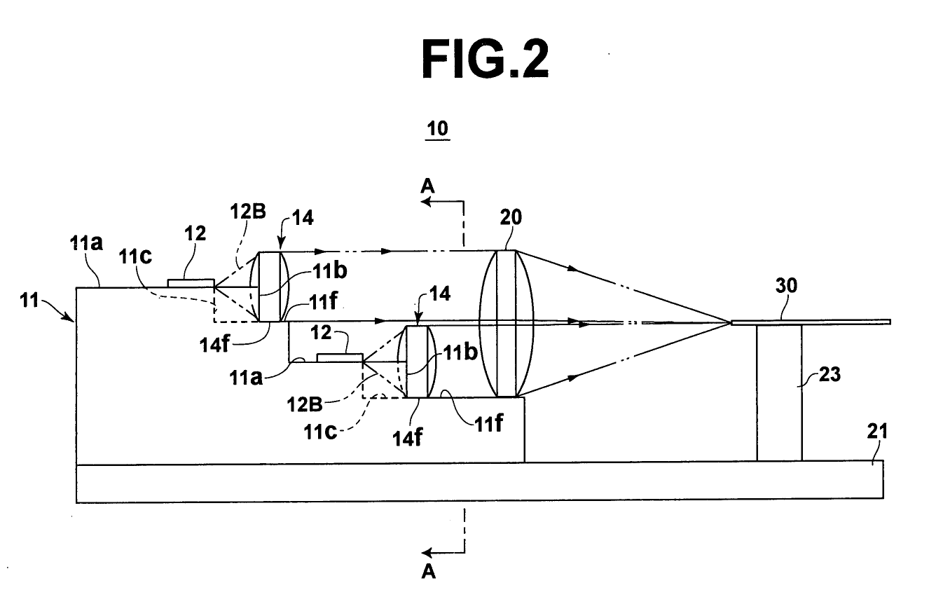

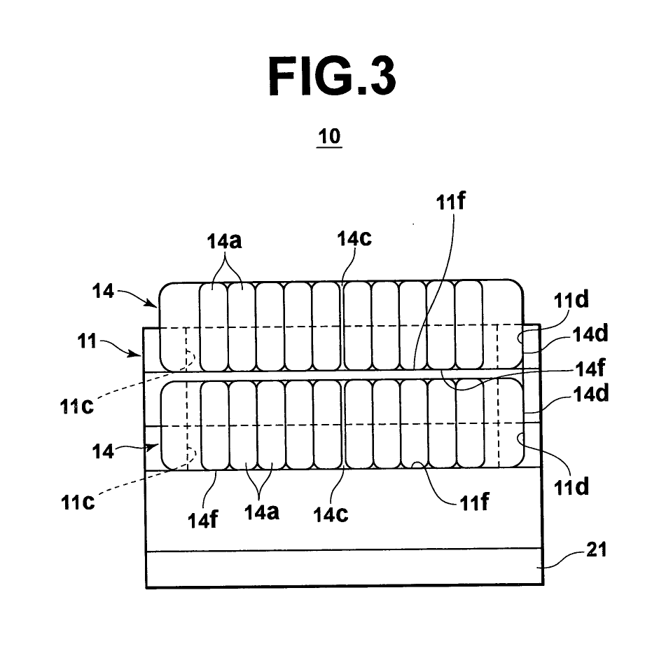

FIGS. 1 and 2 are plan and side views of a laser apparatus according to the first embodiment of the present invention, and FIG. 3 is a front view of a portion of the laser apparatus of FIG. 1, where the portion corresponds to the left half of the construction illustrated in FIG. 2, and is viewed from the position which is indicated by the arrows A-A in FIG. 2. As illustrated in FIGS. 1, 2, and 3, the laser apparatus 10 according to the first embodiment comprises, for example, two sets of a collimator-lens array 14 and two multicavity laser-diode chips 12, which are fixed to a heat block (stem) 11. The heat block 11 is cut out from a piece of copper or copper alloy, and the collimator-lens array 14 in each set is made of synthetic resin or glass.

For example, the multicavity laser-diode chips 12 are each a GaN-based laser diode having five cavities (five light-emission points 12a) and an identical oscillation wavelength of 405 nm. The multicavity laser-diode chips 12 in each set are arranged along the same direction as the direction along which the light-emission points 12a are aligned. In this example, the five light-emission points 12a are aligned with a pitch of 0.35 mm, and laser beams 12B each having an output power of 30 mW are emitted from the respective light-emission points 12a.

On the other hand, the heat block 11 includes two mount portions each having a laser-fixation surface 11a, a first lens-setting surface 11b, a concavity 11c, a second lens-setting surface 11d, and a lens-fixation surface 11f. The laser-fixation surface 11a is a horizontal surface on which the two multicavity laser-diode chips 12 are fixed. The lens-setting surface 11b is a vertical wall surface formed on the forward side of positions to which the multicavity laser-diode chips 12 are fixed, where the forward side is a side toward which the laser beams 12B are emitted from the light-emission points 12a of the multicavity laser-diode chips 12. The concavity 11c is formed so as to avoid occurrence of an eclipse of the laser beams 12B which are emitted from the light-emission points 12a and are divergent. The lens-fixation surface 11f is a horizontal surface. As illustrated in FIG. 2, the two mount portions have different heights and are located in different positions in the direction of the optical axes in order of height so that the heat block 11 has a stepped shape.

In each of the two mount portions, the two multicavity laser-diode chips 12 are fixed to the laser-fixation surface 11a, and the collimator-lens array 14 is fixed to the lens-fixation surface 11f, which faces upward.

The laser-fixation surface 11a in each of the two mount portions of the heat block 11 is smoothed into a highly flat surface with a flatness of 0.5 micrometers or less. In order to ensure thermal diffusion and suppress temperature rise, in each of the two sets, the two multicavity laser-diode chips 12 are fixed to each other and to the laser-fixation surface 11a with brazing material.

The first lens-setting surface 11b in each of the two mount portions of the heat block 11 is formed perpendicular to the light-emission axes of the two multicavity laser-diode chips 12 at a predetermined distance apart from the light-emission points 12a of the two multicavity laser-diode chips 12. The first lens-setting surface 11b is also smoothed into a highly flat surface with a flatness of 0.5 micrometers or less.

The second lens-setting surface 11d in each of the two mount portions of the heat block 11 is a vertical wall surface formed perpendicular to the first lens-setting surface 11b and parallel to the optical axes of the multicavity laser-diode chips 12. The second lens-setting surface 11d is also smoothed into a highly flat surface with a flatness of 0.5 micrometers or less.

The collimator-lens array 14 in each of the two sets is constituted by ten collimator lenses 14a which are arranged along a line and are integrally formed. Each of the collimator lenses 14a has an elongated shape obtained by cutting a portion containing an optical axis of an axially symmetric lens from the axially symmetric lens. The focal length f and the effective height of each collimator lens are respectively 0.9 mm and 1.3 mm. In addition, the length-to-width ratio of each collimator lens is, for example, 3:1 in correspondence with the cross-sectional shape of the laser beam B. Specifically, the pitch with which the five collimator lenses in each of the right and left halves of the ten collimator lenses 14a are arranged is 0.35 mm (with a precision of 0.2 micrometers or less) corresponding to the pitch of the light-emission points 12a in each of the multicavity laser-diode chips 12, and the gap 14c between the right and left halves of the ten collimator lenses 14a is 0.05 mm corresponding to the gap between the two multicavity laser-diode chips 12.

Further, the collimator-lens array 14 in each of the two sets has additional portions which jut out from both ends of the collimator-lens array 14. Two back surfaces of the additional portions of the collimator-lens array 14 are smoothed into highly flat surfaces, and used as two end surfaces 14b which are in contact with the heat block 11.

The lens-fixation surface 11f in each of the two mount portions of the heat block 11, which faces upward, is also smoothed into a highly flat surface with a flatness of 0.5 micrometers or less. A bottom surface 14f of the collimator-lens array 14 is supported by the lens-fixation surface 11f, and fixed to the lens-fixation surface 11f with brazing material. The condensing lens 20, which is explained later, is also fixed to the lens-fixation surface 11f in a similar manner to the collimator-lens array 14.

At the time of attachment of each collimator-lens array 14 to the heat block 11, it is necessary to position the collimator-lens array 14 so that the ten light-emission axes of the multicavity laser-diode chips 12 coincide with the optical axes of the corresponding collimator lenses 14a, respectively. In this example, each collimator-lens array 14 can be easily and accurately positioned as above by placing the collimator-lens array 14 on the lens-fixation surface 11f with the bottom surface 14f down, and holding the end surfaces 14b of the collimator-lens array 14 against the first lens-setting surface 11b, and a side end surface 14d of the collimator-lens array 14 against the second lens-setting surface 11d.

Each of the two mount portions of the heat block 11 and the collimator-lens array 14 fixed to the mount portion have such dimensions that the focal points of the collimator lenses 14a are respectively located at the corresponding light-emission points 12a of the multicavity laser-diode chips 12 when the collimator-lens array 14 is positioned as above. Therefore, when the collimator-lens array 14 is fixed to the heat block 11, the collimator lenses 14a are automatically and appropriately positioned in the direction of the optical axes. That is, the collimator lenses 14a are automatically set in such positions that the divergent laser beams 12B are correctly collimated.

In the first embodiment, the lens-setting surface 11b of heat block 11 is a highly flat surface as explained above. Therefore, it is possible to suppress the movement of the collimator-lens array 14 during the operation for fixing the collimator-lens array 14 to heat block 11, and accurately position the collimator-lens array 14.

In addition, the laser-fixation surface 11a of heat block 11 is also a highly flat surface as explained above. Therefore, it is possible to suppress the movement of the multicavity laser-diode chips 12 during the operation for fixing the multicavity laser-diode chips 12 to the heat block 11, and accurately position the multicavity laser-diode chips 12.

As illustrated in FIGS. 1 and 2, the plurality of laser beams 12B emitted from the laser apparatus 10 according to the first embodiment are optically multiplexed into a single laser beam having high intensity. As illustrated in FIG. 2, the heat block 11 in the laser apparatus 10 is fixed on a base plate 21. In addition, a fiber holder 23 is fixed to the base plate 21, where the fiber holder 23 holds a light-entrance end portion of a multimode optical fiber 30.

In the above construction, the twenty laser beams 12B collimated by the respective collimator lenses 14a in the collimator-lens arrays 14 in the two sets are collected by the condensing lens 20, and converge on a light-entrance end face of a core (not shown) of the multimode optical fiber 30. Then, the twenty collimated laser beams 12B enter and propagate in the core of the multimode optical fiber 30, and are optically multiplexed into a single laser beam. Thus, the optically multiplexed laser beam is output from the multimode optical fiber 30. The multimode optical fiber 30 may be a step-index type, a graded-index type, or any combination thereof.

In the above example, the condensing lens 20 is a truncated lens having a width of 6 mm, an effective height of 1.8 mm, and a focal length of 14 mm. The multimode optical fiber 30 has a core diameter of 50 micrometers and a numerical aperture (NA) of 0.2. The twenty laser beams 12B are collected by the condensing lens 20, and converge on the end face of the core of the multimode optical fiber 30 with a convergence spot diameter of about 40 micrometers. The sum of the loss of the laser beams 12B in the fiber coupling and the loss during the transmission through the collimator lenses 14a and the condensing lens 20 is 20%. Thus, when the output power of each of the laser beams 12B is 30 mW, the output power of the optically multiplexed laser beam becomes 480 mW, i.e., a high-power, high-luminance laser beam is obtained. In addition, when the output power of each of the laser beams 12B is 50 mW, and the loss is the same as the above case, it is possible to obtain a high-power, high-luminance laser beam having an output power of 800 mW.

In the laser apparatus 10 according to the first embodiment, the plurality (two) of sets of the collimator-lens array 14 and the multicavity laser-diode chips 12 are respectively fixed to the plurality (two) of mount portions formed in the heat block 11. Therefore, it is unnecessary to precisely adjust alignment between a plurality of blocks as in the case where a plurality of blocks are stacked, and thus the assembly of the laser apparatus 10 is easy.

In addition, as explained before, in the case where a collimator-lens array is fixed to a heat block with brazing material, the collimator-lens array is likely to move during the cooling process after the fixation. However, in the laser apparatus 10 according to the first embodiment, the collimator-lens array 14 is fixed to the heat block 11 in such a manner that the bottom surface 14f of the collimator-lens array 14 is placed on and supported by the lens-fixation surface 11f of the heat block 11. Therefore, it is possible to restrict the vertical movement of the collimator-lens array 14 relative to the heat block 11, and prevent vertical displacement of the collimator-lens array 14.

Further, reference marks 40 indicating fixation positions of the multicavity laser-diode chips 12 in the direction along which the light-emission points are aligned are formed on each laser-fixation surface 11a of the heat block 11. Therefore, when the multicavity laser-diode chips 12 are mounted on the heat block 11, it is possible to easily position the multicavity laser-diode chips 12 in the direction along which the light-emission points are aligned, by referring to the reference marks 40. Thus, the assembly process of the laser apparatus 10 is simplified, and the accuracy of the positioning of the multicavity laser-diode chips 12 in the horizontal direction can be maintained high.

Alternatively, it is possible to use only one multicavity laser-diode chip having ten light-emission points, instead of using the two multicavity laser-diode chips 12 each having five light-emission points. However, when the number of light-emission points or the chip width increases, a curvature of the array of the light-emission points, so-called “smile,” is more likely to be produced during the manufacturing process. Therefore, in order to prevent the production of the curvature, it is preferable to use a plurality of laser-diode chips each having a relatively small number of light-emission points.

The number of light-emission points in each multicavity laser-diode chip and the number of laser-diode chips are not limited to the numbers mentioned above. For example, it is possible to arrange, in the horizontal and vertical directions, 2×2 multicavity laser-diode chips each having seven light-emission points so as to generate twenty-eight laser beams, or arrange, in the vertical direction, three multicavity laser-diode chips each having five light-emission points so as to generate fifteen laser beams. In the latter case, when the output power of each multicavity laser-diode chip is 30 mW, and the laser beams emitted from the plurality of multicavity laser-diode chips are optically multiplexed into a single laser beam with a loss of 10%, it is possible to obtain a high-luminance laser beam with a high output power of 405 mW.

Further, when the entire construction of FIG. 1, which realizes a fiber module, is hermetically sealed in a sealed container, the lifetime of the fiber module can be increased.

### Second Embodiment

The second embodiment of the present invention is explained below.

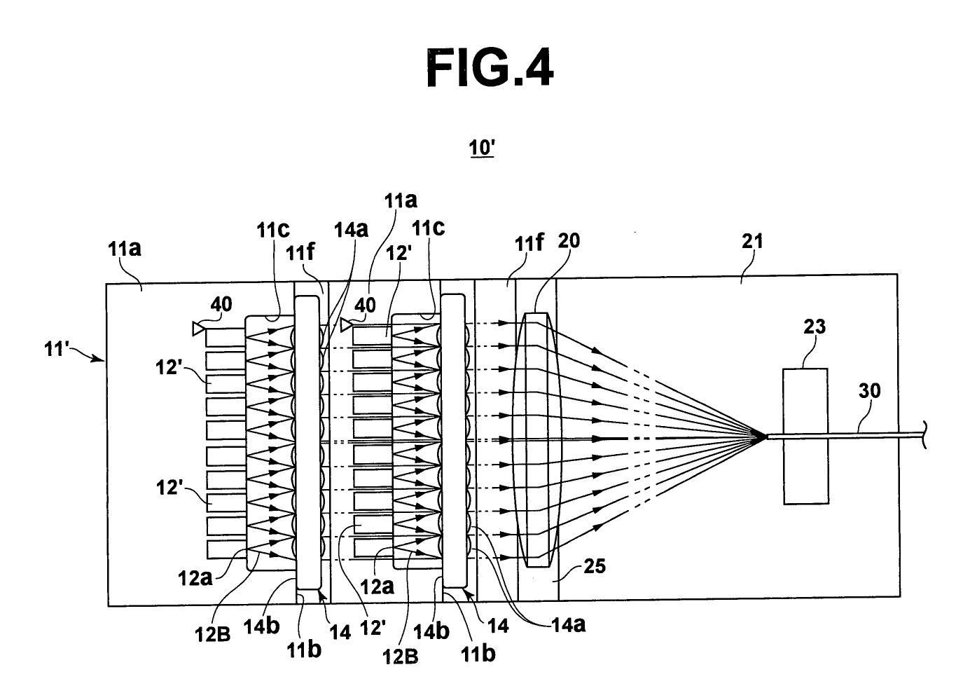

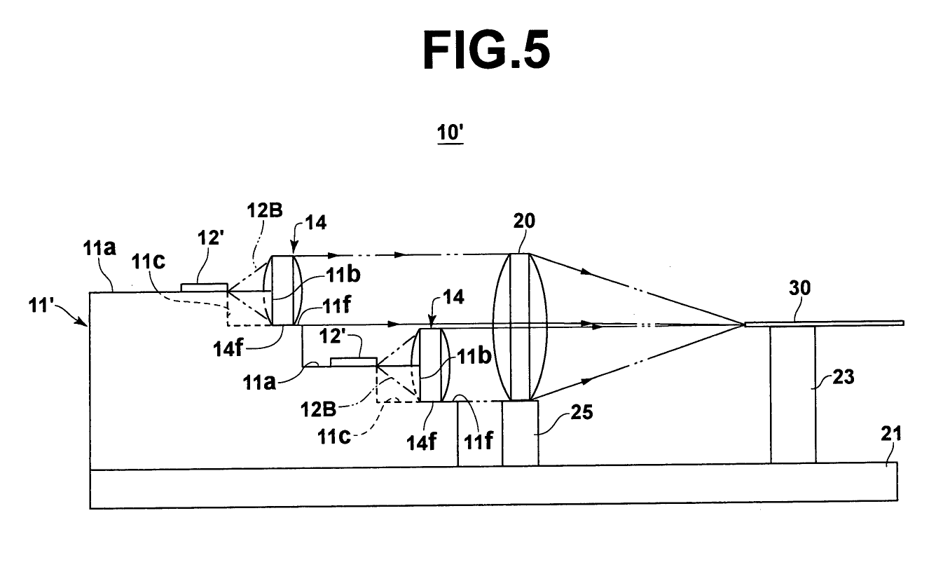

FIGS. 4 and 5 are plan and side views of a laser apparatus 10′ according to the second embodiment of the present invention. In FIGS. 4 and 5, elements having the same functions as the elements in the laser apparatus illustrated in FIGS. 1 through 3 bear the same reference numerals as in FIGS. 1 through 3, respectively, and are not explained below unless necessary.

The laser apparatus 10′ according to the second embodiment is basically different from the laser apparatus 10 illustrated in FIGS. 1 through 3 in that a plurality of single-cavity laser-diode chips each having only a single light-emission point are arranged instead of the multicavity laser-diode chips 12. Specifically, ten GaN-based semiconductor laser chips 12′ are arranged on each of two laser-fixation surfaces 11a of a heat block 11′, where each of the ten GaN-based laser-diode chips 12′ oscillates in multiple transverse modes.

As illustrated in FIGS. 4 and 5, a set of the ten single-cavity laser-diode chips 12′ and a collimator-lens array 14 is fixed to each of a plurality of mount portions of the heat block 11′ which have different heights and are arranged in the direction of the optical axes in order of height. In this case, it is also possible to obtain advantages similar to the advantages of the first embodiment.

In addition, the laser apparatus 10′ according to the second embodiment does not have the second lens-setting surface 11d, which is formed in each mount portion in the laser apparatus illustrated in FIGS. 1 through 3. Therefore, the position of each collimator-lens array 14 in the lateral direction (i.e., in the vertical direction in the plane of FIG. 4) is adjusted by moving the collimator-lens array 14 in the lateral direction when the collimator-lens array 14 is fixed to the heat block 11′.

Further, in the construction of the second embodiment, a condensing-lens holder 25 is provided separately from the heat block 11′, and fixed to the base plate 21, and the condensing lens 20 is fixed to the upper surface of the condensing-lens holder 25.

### Third Embodiment

The third embodiment of the present invention is explained below.

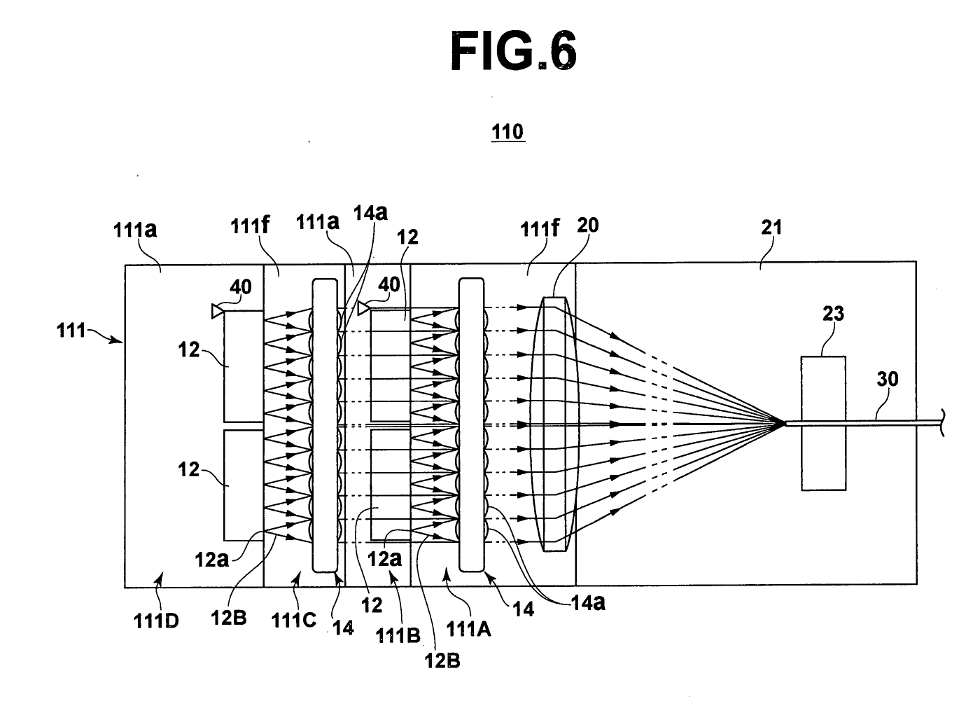

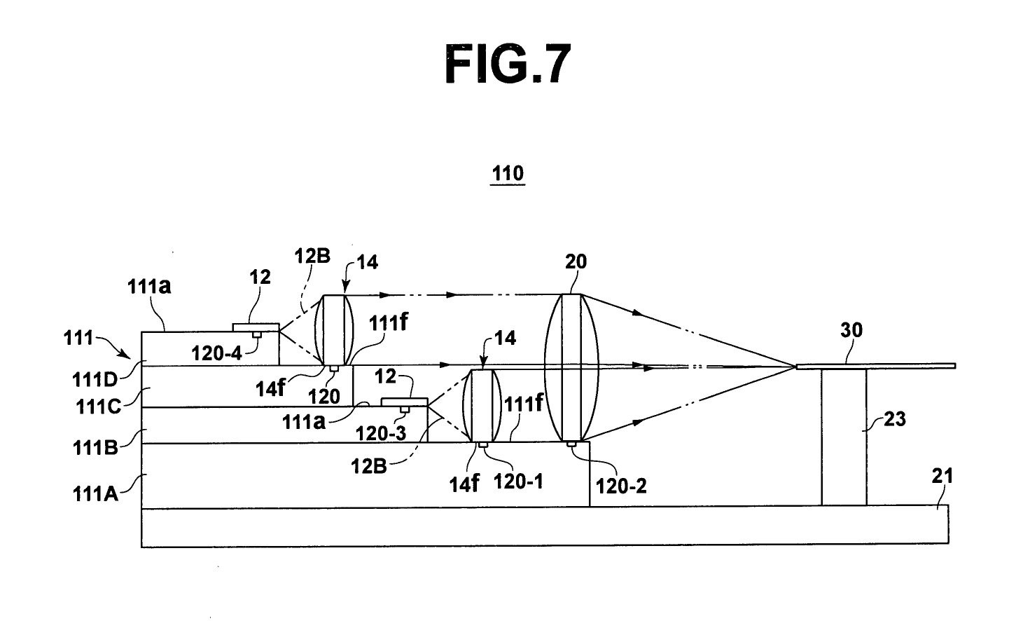

FIGS. 6 and 7 are plan and side views of a laser apparatus 110 according to the third embodiment of the present invention. In FIGS. 6 and 7, elements having the same functions as the elements in the laser apparatus illustrated in FIGS. 1 through 3 bear the same reference numerals as in FIGS. 1 through 3, respectively, and are not explained below unless necessary.

The laser apparatus 110 according to the third embodiment is different from the laser apparatus 10 illustrated in FIGS. 1 through 3 only in that a stacked-plate type heat block 111 is used instead of the heat block 11, and all of the other optical elements in the third embodiment are basically identical to the corresponding elements in the first embodiment.

The heat block 111 is formed by fixing four thin planar plates 111A, 111B, 111C, and 111D to each other, where the planar plates 11A, 111B, 111C, and 111D are stacked in this order. For example, the planar plates 11A, 111B, 111C, and 111D are made of AlN, and metal fixed to each other. Alternatively, the planar plates 111A, 111B, 111C, and 111D may be made of copper, copper alloy, silicon, or the like. When the planar plates 111A, 111B, 111C, and 111D are made of AlN, surfaces at which the planar plates 111A, 111B, 111C, and 111D are fixed to each other, laser-fixation surfaces, and lens-fixation surfaces are metalized, and then the planar plates 111A, 111B, 111C, and 111D are metal fixed to each other. On the other hand, when the planar plates 111A, 111B, 111C, and 111D are made of copper, the surfaces at which the planar plates 111A, 111B, 111C, and 111D are fixed to each other are plated with gold, and then the planar plates 111A, 111B, 111C, and 111D are fixed to each other with solder.

The planar plates 111A, 111B, 111C, and 111D are respectively arranged in correspondence with the mounting positions of the heat block 111 (i.e., in correspondence with the steps constituting the stepped shape of the block 111), where the mounting positions of the heat block 111 are different in the vertical direction and in the direction of the optical axes of the collimator lenses. That is, the upper surface of the portion of the planar plate 111A which protrudes from the edge of the planar plate 111B realizes the lens-fixation surface 111f in one of the two mount portions of the heat block 111, the upper surface of the portion of the planar plate 111B which protrudes from the edge of the planar plate 111C realizes the laser-fixation surface 111a in the one of the two mount portions of the heat block 111, the upper surface of the portion of the planar plate 111C which protrudes from the edge of the planar plate 111D realizes the lens-fixation surface 111f in the other of the two mount portions of the heat block 111, and the upper surface of the planar plate 111D realizes the laser-fixation surface 111a in the other of the two mount portions of the heat block 111.

In this embodiment, a groove 120 having a width of about 1 mm and a depth of about 4 micrometers and extending in the lateral direction (i.e., the vertical direction in the plane of FIG. 6) is formed on the lens-fixation surface 111f of the planar plate 111C by etching, and the surface of the groove 120 is plated with gold. A collimator-lens array 14 can be fixed to the lens-fixation surface 111f of the planar plate 111C by placing solder in the groove 120, precisely positioning the collimator-lens array 14 on the groove 120, and heating the solder.

In addition, two grooves 120-1 and 120-2, which are each similar to the groove 120 on the planar plate 111C, are formed on the lens-fixation surface 111f of the planar plate 111A, and a collimator-lens array 14 and a condensing lens 20 are fixed to the lens-fixation surface 111f of the planar plate 111A with solder in a similar manner to the fixation to the lens-fixation surface 111f of the planar plate 111C.

Alternatively, grooves similar to the grooves 120, 120-1, and 120-2 may be formed on the collimator-lens arrays 14 instead of providing the grooves 120, 120-1, and 120-2 on the lens-fixation surfaces 111f. Further, it is possible to form grooves similar to the grooves 120, 120-1, and 120-2 on both of each collimator-lens array 14 and the lens-fixation surface 111f to which the collimator-lens array 14 is to be fixed.

Furthermore, when a portion of the lens-fixation surface 111f on which the collimator-lens array 14 is to be placed is formed into a convex shape, it is possible to reduce the contact area between the collimator-lens array 14 and the lens-fixation surface 111f, and influence of heat distortion caused by melting of solder.

Moreover, it is possible to apply the fixation method as described above to fixation of multicavity laser-diode chips 12 to the laser-fixation surface 111a on each of the planar plate 111B and the planar plate 111D.

Instead of the use of solder, it is possible to fix the collimator-lens arrays 14, the condensing lens 20, and the multicavity laser-diode chips 12 to the heat block 111 with adhesive.

Since the collimator-lens array 14 and the condensing lens 20 are in contact with the lens-fixation surface 111f of the planar plate 111A, misalignment does not occur when the solder is melted for fixation. Therefore, the collimator-lens array 14 and the condensing lens 20 can be fixed to the heat block 111 with high precision.

As explained above, according to the third embodiment, the collimator-lens arrays 14 and the condensing lens 20 are metal fixed with solder, and the multicavity laser-diode chips 12 are also metal fixed. In order to realize the metal fixation, the lens-fixation surfaces 111f and the laser-fixation surfaces 111a are metalized with Ti/Pt/Au, and then Au is evaporated on the Ti/Pt/Au layers. Since the metal fixation as above is used, it is possible to restrain increase in the contact resistance at the interfaces between the planar plates 111A, 111B, 111C, and 111D, and achieve satisfactory thermal diffusion from the multicavity laser-diode chips 12 to the heat block 111.

The heat block 111, which is formed by stacking and fixing the plurality of planar plates 111A, 111B, 111C, and 111D, can be obtained at lower cost than the heat block cut out from a single piece of material. Therefore, the laser apparatus can be produced at lower cost.

Further, it is possible to form a heat block having the same shape as the heat block 111 by stacking and fixing a greater number of planar plates than the heat block 111. For example, the portion of the heat block 111 constituted by the planar plate 111A in FIG. 7 can be formed by stacking and fixing two or more planar plates. In addition, each of the portions respectively constituted by the planar plates 111B, 111C, and 111D in FIG. 7 can also be formed by stacking and fixing two or more planar plates.

However, when each step in the stepped shape of the heat block 111 is formed with a single planar plate as illustrated in FIG. 7, it is possible to minimize the number of the planar plates. Therefore, the man-hours needed for producing the block can be minimized, and thus the laser apparatus can be produced at the lowest cost.

Since the above planar plates 11A, 111B, 111C, and 111D are normally finished by two-sided polishing, it is possible to obtain the planar plates with high flatness, high degree of parallelism, and precise thicknesses at low cost. Thus, the dimensional precision of the block 111 formed by stacking the planar plates 111A, 111B, 111C, and 111D is comparable to that of the block cut out from a single piece of material. Specifically, the lens-fixation surfaces 111f and the laser-fixation surfaces 111a are required to have a flatness of 0.5 micrometers or less, as explained before, and the heat block 111 satisfies this requirement.

### Fourth Embodiment

The fourth embodiment of the present invention is explained below.

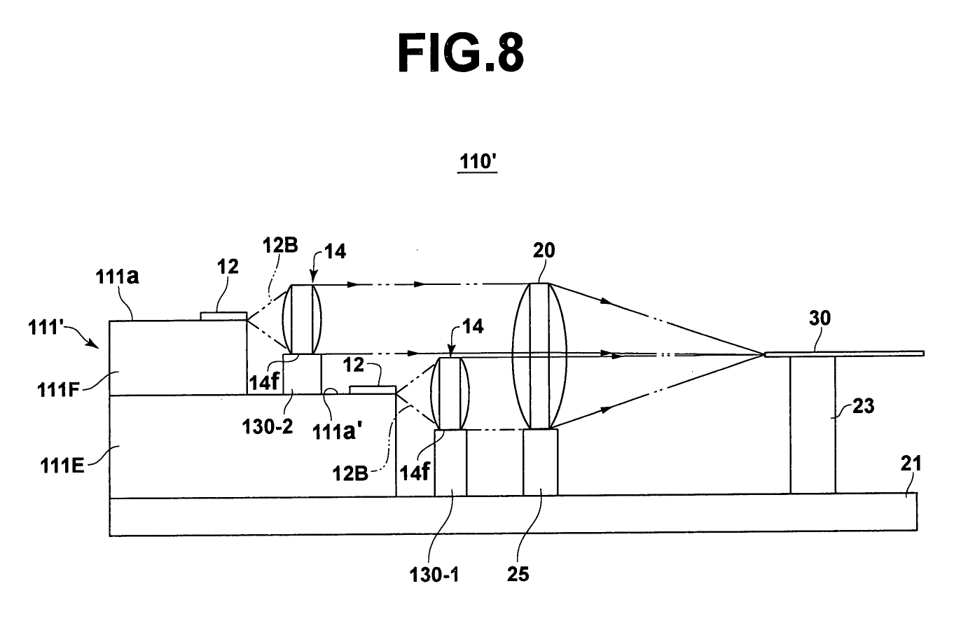

FIG. 8 is a side view of a laser apparatus 110′ according to the fourth embodiment of the present invention. In FIG. 8, elements having the same functions as the elements in the laser apparatuses illustrated in FIGS. 1 through 7 bear the same reference numerals as in FIGS. 1 through 7, respectively, and are not explained below unless necessary.

In the laser apparatus 110′ according to the fourth embodiment, the heat block 111′ is formed by stacking planar plates 11E and 111F on a base plate 21 as illustrated in FIG. 8. In addition, a condensing-lens holder 25 and a lens-array holder 130-1 are fixed to the upper surface of the base plate 21. The condensing lens 20 is fixed to the upper surface of the condensing-lens holder 25, and a collimator-lens array 14 is fixed to the upper surface of the lens-array holder 130-1. Further, another lens-array holder 130-2 is fixed to the upper surface of the planar plate 111E, and another collimator-lens array 14 is fixed to the upper surface of the lens-array holder 130-2. The upper surface of the planar plate 111E contains a laser-fixation surface 111a′, which also serves as a lens-fixation surface.

As explained above, since the condensing-lens holder 25 and the lens-array holders 130-1 and 130-2 are used, the heat block 111′ in the laser apparatus can be formed by stacking the two planar plates 111E and 11F.

The laser apparatus constructed as illustrated in FIG. 8 has similar advantages to the third embodiment of the present invention.

### Fifth Embodiment

Although a plurality of planar plates are stacked in the vertical direction in the third and fourth embodiments, alternatively, it is possible to stack a plurality of planar plates in the direction of the optical axes of the collimator lenses. The laser apparatus according to the fifth embodiment of the present invention uses such a heat block.

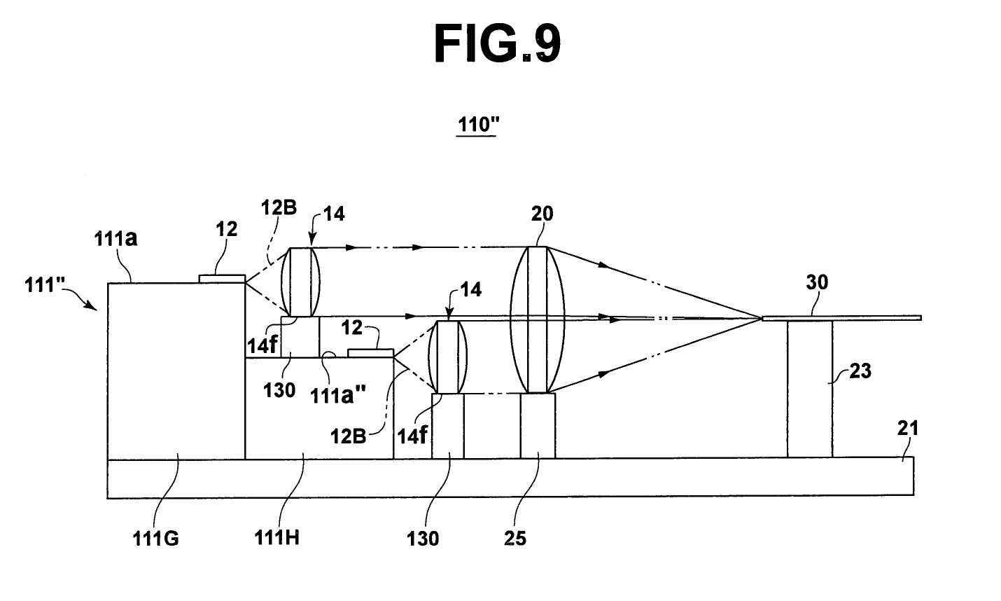

FIG. 9 is a side view of a laser apparatus 110″ according to the fifth embodiment. In FIG. 9, elements having the same functions as the elements in the laser apparatuses illustrated in FIG. 8 bear the same reference numerals as in FIG. 8, respectively, and are not explained below unless necessary.

In the laser apparatus 110″ according to the fifth embodiment, the heat block 111″ is formed by fixing planar plates 111G and 111H to a base plate 21 as illustrated in FIG. 9, where the planar plates 111G and 111H are stacked in the direction of the optical axes of the collimator lenses 14a constituting the collimator-lens array 14. (For example, the collimator lenses 14a are illustrated in FIG. 1.)

The laser apparatus constructed as illustrated in FIG. 9 has similar advantages to the third embodiment of the present invention.

Further, the stepped shape of the heat block 111 illustrated in FIG. 7 can also be formed by stacking the planar plates in the direction of the optical axes of the collimator lenses.

### Additional Matters

(i) The applications of the present invention are not limited to constructions in which a plurality of laser beams are optically multiplexed into a single laser beam by using an optical fiber. For example, the laser apparatuses according to the present invention can be used in a structure in which each of the plurality of laser beams is collected and converged on one of modulation portions constituting a spatial light modulation element and being one-dimensionally arranged, so that each of the plurality of laser beams is individually modulated. For example, such a spatial light modulation element may be a linear liquid-crystal spatial modulation element, a DMD (digital micromirror device), or a GLV (grating light valve).

(ii) It is possible to integrally form the collimator lenses (in FIGS. 1 and 4) and the condensing lens so that the integrally formed lens has both of the collimating and condensing functions.

(iii) The present invention can also be used in applications in which the collimated laser beams are not collected. Even in such applications, the advantages of the present invention are not lost.

(iv) The laser diodes used in the present invention are not limited to the GaN-based laser diodes, and may be made of other materials.

(v) In addition, all of the contents of Japanese patent applications Nos. 2002-287640 and 2003-060047 are incorporated into this specification by reference.

What is claimed is:

1. A laser apparatus comprising:
a block having a stepped shape formed with a plurality of mount portions which have different heights and are arranged in a first direction parallel to an optical axis in order of height; and
a plurality of sets of a collimator-lens array and a plurality of laser diodes, where the collimator-lens array in each of the plurality of sets is constituted by a plurality of collimator lenses which are arranged along a second direction and collimate laser beams emitted from the plurality of laser diodes in said each of the plurality of sets;
wherein said plurality of laser diodes and said collimator-lens array in each of said plurality of sets are fixed to one of said plurality of mount portions so that light-emission points of the plurality of laser diodes in each of the plurality of sets are aligned in a third direction.

2. A laser apparatus according to claim 1, wherein a bottom surface of said collimator-lens array in said each of said plurality of sets is fixed to an upper surface of said one of said plurality of mount portions so that the collimator-lens array is supported by the upper surface of said one of said plurality of mount portions.

3. A laser apparatus according to claim 1, wherein said plurality of laser diodes in each of the plurality of sets is fixed to a surface of one of the plurality of mount portions, and reference marks which indicate fixation positions of the plurality of laser diodes are arranged on said surface of said one of the plurality of mount portions.

4. A laser apparatus according to claim 2, wherein said plurality of laser diodes in each of the plurality of sets is fixed to a surface of one of the plurality of mount portions, and reference marks which indicate fixation positions of the plurality of laser diodes are arranged on said surface of said one of the plurality of mount portions.

5. A laser apparatus according to claim 1, wherein said plurality of laser diodes in each of the plurality of sets are realized by a multicavity laser diode chip having said light-emission points.

6. A laser apparatus according to claim 2, wherein said plurality of laser diodes in each of the plurality of sets are realized by a multicavity laser diode chip having said light-emission points.

7. A laser apparatus according to claim 1, wherein said plurality of laser diodes in each of the plurality of sets are realized by a plurality of multicavity laser diode chips each having a plurality of light-emission points.

8. A laser apparatus according to claim 2, wherein said plurality of laser diodes in each of the plurality of sets are realized by a plurality of multicavity laser diode chips each having a plurality of light-emission points.

9. A laser apparatus according to claim 1, wherein said plurality of laser diodes in each of the plurality of sets are each a single-cavity laser diode chip having a single light-emission point.

10. A laser apparatus according to claim 2, wherein said plurality of laser diodes in each of the plurality of sets are each a single-cavity laser diode chip having a single light-emission point.

11. A laser apparatus according to claim 1, wherein said block is formed by combining a plurality of planar plates which are stacked in one of a vertical direction and said first direction.

12. A laser apparatus according to claim 2, wherein said block is formed by combining a plurality of planar plates which are stacked in one of a vertical direction and said first direction.

13. A laser apparatus according to claim 11, wherein said plurality of planar plates are arranged in correspondence with steps constituting the stepped shape, respectively.

14. A laser apparatus according to claim 12, wherein said plurality of planar plates are arranged in correspondence with steps constituting the stepped shape, respectively.
